(19) United States
(12) Patent Application Publication
(10) Pub. No.: US 2023/0329291 A1
(43) Pub. Date: Oct. 19, 2023

(54) GENERATING A MOISTURE-MIGRATION RESISTANT GRANOLA AND METHODS OF USE THEREOF

(71) Applicant: Oats Overnight, Inc., Tempe, AZ (US)

(72) Inventors: Karla Gattey, Tempe, AZ (US); Winnie Y. Liu, Foster City, CA (US); Andrea Thyen, Foster City, CA (US); Debra D. Abram, Foster City, CA (US); Laurie A. Troiani, Foster City, CA (US); Sandip Parikh, Scottsdale, AZ (US)

(21) Appl. No.: 17/720,570

(22) Filed: Apr. 14, 2022

(51) Int. Cl. A23L 7/126; A23L 33/125; A23L 33/115

(52) U.S. Cl. CPC A23L 7/126; A23L 33/125; A23L 33/115

(57) ABSTRACT

A method comprising selecting at least one granola; mixing at least two additives with a selected granola and at least one sugar; coating the at least one granola with a dry corn syrup solid; generating a first moisture barrier that encapsulates a coated granola; dividing the granola cluster into at least one predetermined size; reducing a temperature associated with the granola cluster; generating a second moisture barrier that encapsulates the first moisture barrier that encapsulates the coated granola; and storing the coated granola cluster in a climate-controlled package for at least twelve hours.

### FIELD OF TECHNOLOGY

The present disclosure generally relates to a process configured for dynamically generating a moisture-migration resistant granola and methods of use thereof.

### BACKGROUND OF TECHNOLOGY

Typically, when a granola and/or grain is introduced to moisture, present technology allows the granola to absorb the moisture at varying rates based on a plurality of factors. The allowance of the granola to absorb the moisture based on the mobility of the moisture or lack of layers to prevent moisture absorption generates a highly saturated granola. The generation of the highly saturated granola may decrease rigidity that may result in a decreased level of efficiency in dynamically generating the moisture-migration resistant granola.

### SUMMARY OF DESCRIBED SUBJECT MATTER

In some embodiments, the present disclosure provides an exemplary technically improved method that includes at least the following steps of selecting at least one granola from a plurality of granola, where the at least one granola is a granola mixture; coating the at least one granola with a dry corn syrup solid, where the dry corn syrup solid is a powder; generating a first moisture barrier that encapsulates a coated granola based on baking the coated granola for a predetermined period of time at a predetermined temperature; generating a second moisture barrier that encapsulates the first moisture barrier that encapsulates the coated granola by coating the first moisture barrier that encapsulates the coated granola with a fat that has a melting point above a predetermined temperature threshold, where the predetermined temperature threshold associated with the melting point of the fat is at least 90 degrees Fahrenheit, where the fat comprises at least 14% of the second moisture barrier, where the second moisture barrier that encapsulates the first moisture barrier that encapsulates the coated granola is a granola cluster; reducing a temperature associated with the granola cluster by cooling the granola cluster for a different predetermined period of time; dividing the granola cluster into at least one predetermined size, where the at least one predetermined size is a range from 6.35 mm to 25.5 mm; introducing the granola cluster to at least one liquid of a plurality of liquids for at least twelve hours, where the granola cluster with the at least one liquid is a granola solution; and storing the granola solution at less than 40 degrees Fahrenheit.

In some embodiments, the present disclosure provides an exemplary technically improved process that that includes at least the following steps of selecting at least one granola from a plurality of granola, where the at least one granola is a granola mixture; coating the at least one granola with a dry corn syrup solid, where the dry corn syrup solid is a powder; generating a first moisture barrier that encapsulates a coated granola based on baking the coated granola for a predetermined period of time at a predetermined temperature; generating a second moisture barrier that encapsulates the first moisture barrier that encapsulates the coated granola by coating the first moisture barrier that encapsulates the coated granola with a fat that has a melting point above a predetermined temperature threshold, where the predetermined temperature threshold associated with the melting point of the fat is at least 90 degrees Fahrenheit, wherein the fat comprises at least 14% of the second moisture barrier, where the second moisture barrier that encapsulates the first moisture barrier that encapsulates the coated granola is a granola cluster; reducing a temperature associated with the granola cluster by cooling the granola cluster for a different predetermined period of time; dividing the granola cluster into at least one predetermined size, where the at least one predetermined size is a range from 6.35 mm to 25.5 mm; introducing the granola cluster to at least one liquid of a plurality of liquids for at least twelve hours, where the granola cluster with the at least one liquid is a granola solution; and storing the granola solution at less than 40 degrees Fahrenheit.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a flowchart illustrating operational steps for dynamically generating a moisture-migration resistant granola with at least two moisture barriers, in accordance with at least some embodiments of the present disclosure.

FIG. 2 is a flowchart illustrating operational steps for dynamically generating a moisture-migration resistant granola with at least three moisture barriers, in accordance with at least some embodiments of the present disclosure.

FIG. 3 depicts an exemplary cross-sectional view of a dynamically generated moisture-migration resistant granola, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a user interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

At least some embodiments of the present disclosure provide technological solution(s) to a technological problem associated with allowing moisture migration within a type of granola. The technological problem associated with allowing moisture migration within a type of granola arises due to the type of granola being introduced to at least one liquid for at least thirty minutes, which increases a saturation value associated with the granola. In some embodiments, the present disclosure may generate a first moisture barrier that encapsulates a coated granola based on baking the coated granola and generate a second moisture barrier that encapsulates the first moisture barrier that encapsulates the coated granola. In some instances, the type of granola may include at least one protein of a plurality of proteins. In some embodiments, the present disclosure may generate a third moisture barrier that encapsulates the second moisture barrier that encapsulates the first moisture barrier that encapsulates the coated granola, where the third moisture layer includes a chocolate and/or yogurt compound. In some embodiments, the present disclosure provides a technological solution that prevents moisture migration through a granola based on generating at least two moisture barriers via a combination of baking, coating, and cooling dry corn syrup solids and a fat with a melting point that meets or exceeds a predetermined temperature threshold. In some embodiments, the generation of the first moisture barrier is in response to coating the granola with a dry corn syrup solid powder and caramelizing the dry corn syrup solid powder by baking the coated granola for twenty to thirty minutes at 300-350 degrees Fahrenheit. In some embodiments, the generation of the second moisture barrier includes at least one type of fat, where the at least one type of fat may be at least one of, but not limited to, bee's wax, candelilla wax, rice wax, palm fat, coconut fat, and/or cocoa fat.

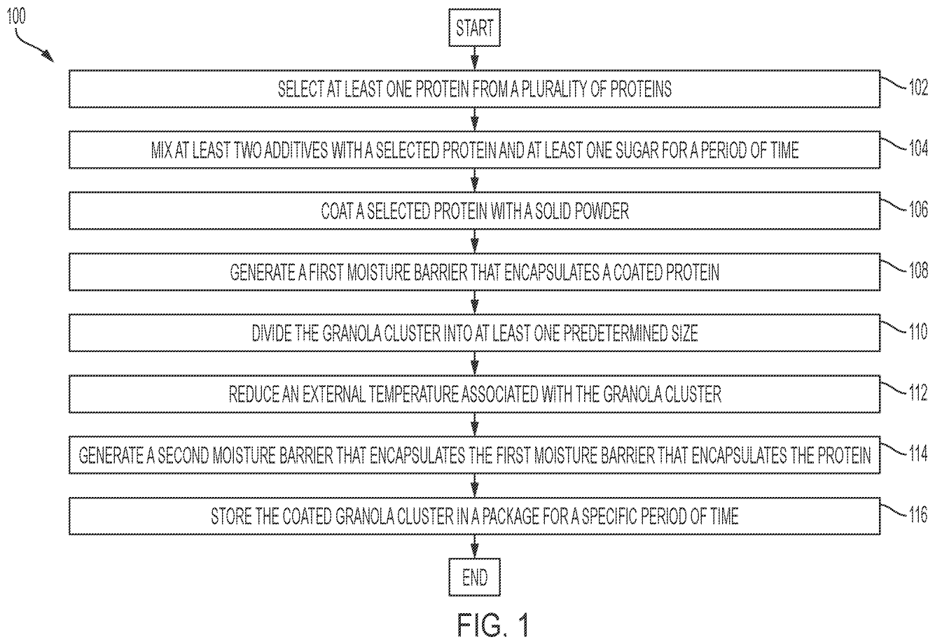

FIG. 1 is a flowchart 100 illustrating operational steps for dynamically generating a moisture-migration resistant granola with at least two moisture barriers, in accordance with at least some embodiments of the present disclosure.

In step 102, an illustrative process 101 (not shown in FIG. 1) associated with a moisture-migration resistant granola 103 may select at least one granola from a plurality of granolas. In some embodiments, the illustrative process 101 may select the at least one granola from a plurality of granolas based on a plurality of factors. In some embodiments, the plurality of factors associated with the selection of the at least one granola may refer to at least one of, but not limited to, a type of granola, a size, a rigidness value, and/or a saturation value. For example, the illustrative process 101 may select an oat-type granola. In some instances, the type of granola may include at least one protein of a plurality of proteins.

In step 104, the illustrative process 101 associated with the moisture-migration resistant granola 103 may mix at least two additives with a selected granola and at least one sugar for a period of time. In some instances, additives may include rolled oat, steel cut oat, instant oat, oat flour, rice flour, spelt flour, quinoa, couscous, barley chickpeas, and cauliflower. In some instances, the at least one sugar may be one of, but not limited to, cane sugar, beet sugar, honey, maple syrup, agave syrup, and coconut sugar. In some embodiments, the additives may include at least a rolled oat, oat flour, quinoa or cane sugar, and the illustrative process 101 may mix such ingredients for at least one minute to generate a granola mixture. In some embodiments, the illustrative process 101 may further add a rice syrup, an oil, and/or at least one flavoring liquid to the granola mixture continually for at least three minutes to generate a wet granola mixture.

In step 106, the illustrative process 101 associated with the moisture-migration resistant granola 103 may coat a selected granola with a solid powder. In some instances, the solid powder may include dry corn syrup, dry golden syrup, dry brown rice syrup, and dry cane syrup. In some embodiments, the illustrative process 101 may coat the selected granola with a dry corn syrup solid by continually applying the solid powder to the selected granola until a uniform coating is formed on the selected granola. In some instances, the dry corn syrup solid may refer to a dry corn syrup powder. In one embodiment, the solid powder may be continually applied to the selected granola until there is a uniform coating.

In step 108, the illustrative process 101 associated with the moisture-migration resistant granola 103 may generate a first moisture barrier that encapsulates a coated granola. In some embodiments, the illustrative process 101 may generate the first moisture barrier that encapsulates a coated granola by baking the selected granola uniformly coated with the dry corn syrup solid powder for a predetermined period of time at a predetermined temperature. In some instances, the predetermined period of time may refer to a range with a minimum limit of twenty minutes and a maximum limit of thirty minutes. In some instances, the minimum limit may be ten minutes, twelve minutes, fifteen minutes, eighteen minutes, twenty minutes, twenty-two minutes, and twenty-five minutes. In some instances, the maximum limit may be twenty minutes, twenty-five minutes, thirty minutes, thirty-five minutes, and forty minutes. In some embodiments, the predetermined temperature may refer to a range with a minimum point of 300 degrees Fahrenheit (“F”) and a maximum point of 350 degrees F. In some instances, the minimum point may be any degree between 250-349 degrees F. In some instances, the maximum point may be any degree between 301-425 degrees F. In some embodiments, the illustrative process 101 may generate the first moisture barrier that encapsulates the coated granola by caramelizing the dry corn syrup solid coated on the selected granola. In some embodiments, the caramelized dry corn syrup solid may refer to the first moisture barrier associated with the granola cluster.

In step 110, the illustrative process 101 associated with the moisture-migration resistant granola 103 may divide the granola cluster into at least one predetermined size. In some embodiments, the illustrative process 101 may divide the granola cluster into the at least one predetermined size by breaking the granola cluster into smaller pieces. In some embodiments, the at least one predetermined size may refer to a range of sizes with a minimum size of 6.35 mm and a maximum size of 25.5 mm. In some instances, the minimum size of the divided granola cluster may be any size between 4 mm to 7 mm. In some instances, the maximum size of the granola cluster may be any size between 25.5 mm and 40 mm.

In step 112, the illustrative process 101 associated with the moisture-migration resistant granola 103 may reduce an external temperature associated with the granola cluster. In some embodiments, the illustrative process 101 may reduce the external temperature associated with the granola cluster by cooling the granola cluster to reach a predetermined cooling temperature. In some embodiments, the illustrative process 101 may cool the granola cluster by applying particles of air that are under at least forty degrees F. for at least thirty minutes. For example, one may place the granola cluster in a refrigerator or a cooler for a period of time to reach the predetermined cooling temperature associated with the selected granola.

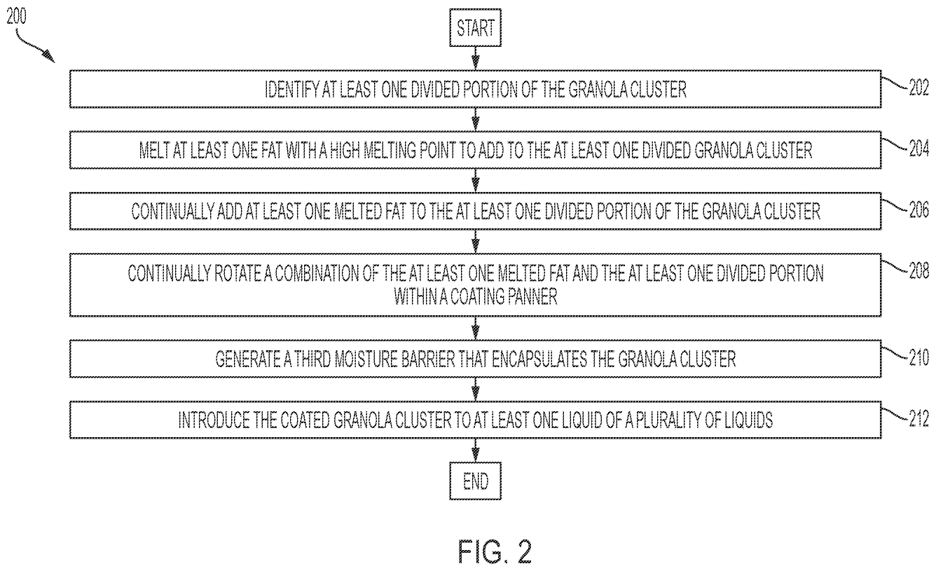

In step 114, the illustrative process 101 associated with the moisture-migration resistant granola 103 may generate a second moisture barrier that encapsulates the first moisture barrier that encapsulates the coated granola. In some embodiments, the illustrative process 101 may generate the second moisture barrier that encapsulates the first moisture barrier that encapsulates the granola cluster by coating the first moisture barrier with a fat. This step will be further explained in FIG. 2. In some embodiments, the fat may refer to at least one fat with a melting point that meets or exceeds a predetermined temperature threshold. In some instances, the predetermined temperature threshold may refer to at least 90 degrees F. In some instances, the fat may refer to at least one of, but not limited to, coconut fat, palm fat, bees wax, carnauba wax, and/or rice wax. In some embodiments, the generated second moisture barrier is made of at least fourteen percent of the fat. In some embodiments, the generated second moisture barrier is made of no more than seventy-five percent of the fat. In some embodiments, the illustrative process 101 may generate the second moisture barrier that encapsulates the first moisture barrier by melting the fat to 90-180 degrees F. In some embodiments, the illustrative process 101 may gradually add the melted fat to the granola cluster as a coat while a coating panner is continuously rotating. In some embodiments, the illustrative process 101 may cool the granola cluster coated with the added, melted fat to at least forty degrees F. In some embodiments, the generation of the second moisture barrier may refer to a coated granola cluster.

In step 116, the illustrative process 101 associated with the moisture-migration resistant granola 103 may store the coated granola cluster in a package for a specific period of time. In some embodiments, the period of time may be at least twelve hours. In some embodiments, the illustrative process 101 may store the coated granola cluster in the climate-controlled package by transporting the coated granola cluster through a cooling tunnel to reduce the external temperature of the coated granola cluster to at least forty degrees.

In some embodiments, the illustrative process 101 associated with the moisture-migration resistant granola 103 may introduce the coated granola cluster to at least one liquid of a plurality of liquids. In some embodiments, the illustrative process 101 may introduce the granola cluster to the at least one liquid for at least twelve hours. In some embodiments, the at least one liquid may refer to at least one type of milk. For example, the granola cluster may be introduced with at least one of, but not limited to, whole milk, oat milk, almond milk, soy milk, dairy-free milk, and/or water-diluted milk. In some embodiments, the illustrative process 101 may generate a third moisture barrier that encapsulates the granola cluster by coating the granola cluster with a fat mixture. In some instances, the third moisture barrier that encapsulates the granola cluster may refer to a chocolate and/or yogurt coating. In some instances, the fat mixture may refer to a combination of coating compounds that contain palm fat, cocoa fat, sunflower fat, and soy lecithin.

FIG. 2 is a flowchart 200 illustrating operational steps for dynamically generating a moisture-migration resistant granola with at least three moisture barriers, in accordance with one or more embodiments of the present disclosure.

In step 202, the illustrative process 101 associated with the moisture-migration resistant granola 103 may identify at least one divided portion of the granola cluster. In some embodiments, the illustrative process 101 may identify the at least one divided portion of the granola cluster by determining an accurate size of the granola cluster meets a predetermined size threshold. In some instances, the type of granola may include at least one protein of a plurality of proteins.

In step 204, the illustrative process 101 associated with the moisture-migration resistant granola 103 may melt at least one fat with a high melting point to add to the at least one divided portion of granola cluster. In some embodiments, the illustrative process 101 may melt the at least one fat with a high melting point by warming the at least one fat to a temperature of at least 100 degrees F. In some embodiments, the at least one fat with a high melting point may refer to at least one of, but not limited to, coconut fat, palm fat, bees wax, carnauba wax, and/or rice wax.

In step 206, the illustrative process 101 associated with the moisture-migration resistant granola 103 may continually add at least one melted fat to the at least one divided portion of the granola cluster. In some embodiments, the illustrative process 101 may gradually and continuously coat the at least one divided portion of the granola cluster with the at least one melted fat by continually adding the melted fat to the at least one divided portion of the granola cluster while the at least one divided portion of the granola cluster is within a coating panner.

In step 208, the illustrative process 101 associated with the moisture-migration resistant granola 103 may continually rotate a combination of the at least one melted fat and the at least one divided portion within a coating panner. In some embodiments, the illustrative process 101 may continually rotate the combination of the at least one melted fat and the at least one divided portion of the granola cluster to uniformly coat the at least one divided portion of the granola cluster with the melted fat.

In step 210, the illustrative process 101 associated with the moisture-migration resistant granola 103 may generate a third moisture barrier that encapsulates the granola cluster by coating the granola cluster with a fat mixture. In some embodiments, the illustrative process 101 may generate the third moisture barrier that encapsulates the coated granola cluster by coating the coated granola cluster with an additional fat mixture. In some instances, the additional fat mixture may refer to a chocolate, a yogurt and/or at least one other coating compound. For example, the illustrative process 101 may generate the third moisture barrier that encapsulates the coated granola cluster by coating the coated granola cluster with palm fat, cocoa fat, and soy lecithin.

In step 212, the illustrative process 101 associated with the moisture-migration resistant granola 103 may introduce the coated granola cluster to at least one liquid of a plurality of liquids. In some embodiments, the illustrative process 101 may introduce the coated granola cluster to the at least one liquid for at least twelve hours. In some embodiments, the at least one liquid may refer to at least one type of milk. For example, the granola cluster may be introduced with at least one of, but not limited to, whole milk, oat milk, almond milk, soy milk, dairy-free milk, and/or water-diluted milk.

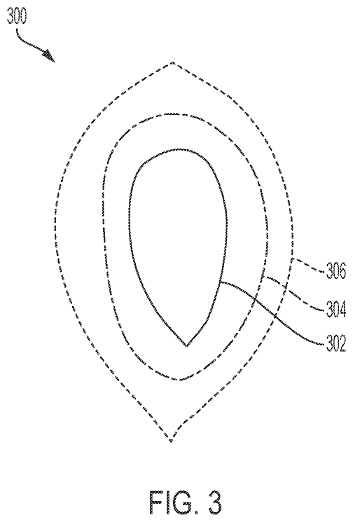

FIG. 3 depicts a cross-sectional exemplary diagram 300 of an exemplary moisture-migration resistant granola, in accordance with at least one or more embodiments of the present disclosure.

In FIG. 3, a granola mixture 302 is centrally located within a first moisture barrier 304, which in some embodiments may be made of a caramelized dry corn syrup solid power, and a second moisture barrier 306, which in some embodiments may be made of a melted fat with a high melting point and cooled to generate a coating. In some embodiments, the granola mixture 302 may refer to at least a rolled oat, oat flour, quinoa cane sugar, a rice syrup, an oil, and/or at least one flavoring liquid to generate the granola mixture. In some embodiments, the first moisture barrier 304 may refer to a dry corn syrup solid power that is sprinkled on the granola mixture 302 and baked at the predetermined temperature for the predetermined period of time to generate the first moisture barrier 304. In some embodiments, the second moisture barrier 306 may refer to a melted fat with a high melting point uniformly coated to the coated granola cluster.

At least some aspects of the present disclosure will now be described with reference to the following numbered clauses.
1. A method may include: selecting at least one granola from a plurality of granolas, where the at least one granola is an oat; mixing at least two additives with a selected granola and at least one sugar for a period of time, where a mixture of the at least two additives and at least one sugar with the selected granola is a granola mixture; coating the at least one granola with a dry corn syrup solid; generating a first moisture barrier that encapsulates a coated granola based on baking the coated granola for a predetermined period of time at a predetermined temperature; where the first moisture barrier comprises at least two percent of the dry corn syrup solid powder; dividing the granola cluster into at least one predetermined size; reducing a temperature associated with the granola cluster by cooling the granola cluster for a different predetermined period of time; generating a second moisture barrier that encapsulates the first moisture barrier that encapsulates the coated granola by coating the first moisture barrier that encapsulates the coated granola with a fat that has a melting point above a predetermined temperature threshold, where the predetermined temperature threshold associated with the melting point of the fat is 90 degrees Fahrenheit, where the fat includes at least fourteen percent of the second moisture barrier; wherein the second moisture barrier that encapsulates the first moisture barrier that encapsulates the coated granola is a granola cluster; and storing the coated granola cluster in a climate-controlled package for at least twelve hours.
2. The method according to clause 1, where the at least two additives are an oat flour and quinoa.
3. The method according to clause 1 or 2, where the at least one sugar is a cane sugar.
4. The method according to clause 1, 2 or 3, where the predetermined period of time associated with baking the coated granola is at least thirty minutes.
5. The method according to clause 1, 2, 3 or 4, where the predetermine temperature associated with baking the coated granola is at least 300 degrees Fahrenheit.
6. The method according to clause 1, 2, 3, 4 or 5, further including baking the coated granola within a rack oven for the predetermined period of time at the predetermined temperature.
7. The method according to clause 1, 2, 3, 4, 5 or 6, where dividing the granola cluster into the at least one predetermined size comprises utilizing a rotatory screen to break the granola cluster into divided portions.
8. The method according to clause 1, 2, 3, 4, 5, 6 or 7, where reducing the external temperature associated with the granola cluster includes utilizing a cooling tunnel to apply cooled particles of air that are under at least forty degrees Fahrenheit for at least thirty minutes.
9. The method according to clause 1, 2, 3, 4, 5, 6, 7 or 8, where the predetermined temperature threshold associated with the melting point of the fact is at least 90 degrees Fahrenheit.
10. The method according to clause 1, 2, 3, 4, 5, 6, 7, 8 or 9, further including generating a third moisture layer barrier that encapsulates the granola cluster by coating the granola cluster with a fat mixture, where the fat mixture is a combination of palm fat, cocoa fat, and soy lecithin.
11. The method according to clause 1, 2, 3, 4, 5, 6, 7, 8, 9, or 10, further including introducing a coated granola cluster to the at least one liquid for at least twelve hours, where the at least one liquid is at least one milk.
12. A method including: selecting at least one granola from a plurality of granolas, where the at least one granola is an oat; mixing at least two additives with a selected granola and at least one sugar for a period of time, where a mixture of the at least two additives and the at least one sugar with the selected granola is a granola mixture; coating the at least one granola with a dry corn syrup solid; generating a first moisture barrier that encapsulates a coated granola based on baking the coated granola for a predetermined period of time at a predetermined temperature; where the first moisture barrier comprises at least two percent of the dry corn syrup solid powder; dividing the granola cluster into at least one predetermined size; reducing a temperature associated with the granola cluster by cooling the granola cluster for a different predetermined period of time; generating a second moisture barrier that encapsulates the first moisture barrier by coating the first moisture barrier with a fat that has a melting point above a predetermined temperature threshold, where the predetermined temperature threshold associated with the melting point of the fat is 90 degrees Fahrenheit, where the fat includes at least fourteen percent of the second moisture barrier; where the second moisture barrier that encapsulates the first moisture barrier that encapsulates the coated granola is a granola cluster; generating a third moisture layer barrier that encapsulates the granola cluster by coating the granola cluster with a fat mixture, where the fat mixture includes one or more of palm fat, cocoa fat, or soy lecithin; introducing a coated granola cluster to the at least one liquid for at least twelve hours, where the at least one liquid is at least one milk, where the coated granola cluster introduced to the at least one liquid forms a granola solution; and storing the granola solution in a climate-controlled package for at least twelve hours.
13. The method according to clause 12, where the at least two additives are an oat flour and quinoa.
14. The method according to clause 12 or 13, where the predetermined period of time associated with baking the coated granola is at least thirty minutes.
15. The method according to clause 12, 13, or 14, further including baking the coated granola within a rack oven for the predetermined period of time at the predetermined temperature.
16. The method according to clause 12, 13, 14 or 15, where dividing the granola cluster into the at least one predetermined size includes utilizing a rotatory screen to break the granola cluster into divided portions.
17. The method according to clause 12, 13, 14, 15, or 16, where reducing the external temperature associated with the granola cluster includes utilizing a cooling tunnel to apply cooled particles of air that are under at least forty degrees Fahrenheit for at least thirty minutes.
18. A moisture-migration resistant granola including: a granola mixture; a first moisture layer encapsulating the granola mixture, where the first moisture layer includes a caramelized dry corn syrup solid power; and a second moisture layer encapsulating the first moisture layer, where the second moisture layer includes a melted fat with a melting point that meets or exceeds a predetermined temperature threshold.
19. The moisture-migration resistant granola according to clause 18, further including a third moisture layer encapsulating the second moisture layer, where the third moisture layer includes one or more of palm fat, cocoa fat, or soy lecithin.
20. The moisture-migration resistant granola according to clause 18, wherein the predetermined temperature threshold is 90 degrees Fahrenheit.

What is claimed is:

1. A method comprising:
selecting at least one granola from a plurality of granolas, wherein the at least one granola is an oat;
mixing at least two additives with a selected granola and at least one sugar for a period of time, wherein a mixture of the at least two additives and the at least one sugar with the selected granola is a granola mixture;
coating the at least one granola with a dry corn syrup solid;
generating a first moisture barrier that encapsulates a coated granola based on baking the coated granola for a predetermined period of time at a predetermined temperature, wherein the first moisture barrier comprises at least two percent of the dry corn syrup solid powder;
dividing the granola cluster into at least one predetermined size;
reducing a temperature associated with the granola cluster by cooling the granola cluster for a different predetermined period of time;
generating a second moisture barrier that encapsulates the first moisture barrier by coating the first moisture barrier with a fat that has a melting point above a predetermined temperature threshold, wherein:
the predetermined temperature threshold associated with the melting point of the fat is 90 degrees Fahrenheit,
the fat comprises at least fourteen percent of the second moisture barrier, and
the second moisture barrier is a granola cluster; and
storing the coated granola cluster in a climate-controlled package for at least twelve hours.

2. The method of claim 1, wherein the at least two additives comprise an oat flour and quinoa.

3. The method of claim 1, wherein the at least one sugar is a cane sugar.

4. The method of claim 1, wherein the predetermined period of time associated with baking the coated granola is at least thirty minutes.

5. The method of claim 1, wherein the predetermined temperature associated with baking the coated granola is at least 300 degrees Fahrenheit.

6. The method of claim 1, further comprising baking the coated granola within a rack oven for the predetermined period of time at the predetermined temperature.

7. The method of claim 1, wherein dividing the granola cluster into the at least one predetermined size comprises utilizing a rotatory screen to break the granola cluster into divided portions.

8. The method of claim 1, wherein reducing the external temperature associated with the granola cluster comprises by utilizing a cooling tunnel to apply cooled particles of air that are under at least forty degrees Fahrenheit for at least thirty minutes.

9. The method of claim 1, wherein the predetermined temperature threshold associated with the melting point of the fat is at least 90 degrees Fahrenheit.

10. The method of claim 1, further comprising generating a third moisture layer barrier that encapsulates the granola cluster by coating the granola cluster with a fat mixture, wherein the fat mixture is a combination of palm fat, cocoa fat, sunflower fat and/or soy lecithin.

11. The method of claim 1, further comprising introducing a coated granola cluster to the at least one liquid for at least twelve hours, wherein the at least one liquid is at least one milk.

12. A method comprising:
selecting at least one granola from a plurality of granolas, wherein the at least one granola is an oat;
mixing at least two additives with a selected granola and at least one sugar for a period of time, wherein a mixture of the at least two additives and at least one sugar with the selected granola is a granola mixture;
coating the at least one granola with a dry corn syrup solid;
generating a first moisture barrier that encapsulates a coated granola based on baking the coated granola for a predetermined period of time at a predetermined temperature;
wherein the first moisture barrier comprises at least two percent of the dry corn syrup solid powder;
dividing the granola cluster into at least one predetermined size;
reducing a temperature associated with the granola cluster by cooling the granola cluster for a different predetermined period of time;
generating a second moisture barrier that encapsulates the first moisture barrier by coating the first moisture barrier with a fat that has a melting point above a predetermined temperature threshold,
wherein the predetermined temperature threshold associated with the melting point of the fat is 90 degrees Fahrenheit,
wherein the fat comprises at least fourteen percent of the second moisture barrier;
wherein the second moisture barrier that encapsulates the first moisture barrier that encapsulates the coated granola is a granola cluster;
generating a third moisture layer barrier that encapsulates the granola cluster by coating the granola cluster with a fat mixture, wherein the fat mixture comprises one or more of palm fat, cocoa fat, or soy lecithin;
introducing a coated granola cluster to the at least one liquid for at least twelve hours,
wherein the at least one liquid is at least one milk,
wherein the coated granola cluster introduced to the at least one liquid forms a granola solution; and
storing the granola solution in a climate-controlled package for at least twelve hours.

13. The method of claim 12, wherein the at least two additives are an oat flour and quinoa.

14. The method of claim 12, wherein the predetermined period of time associated with baking the coated granola is at least thirty minutes.

15. The method of claim 12, further comprising baking the coated granola within a rack oven for the predetermined period of time at the predetermined temperature.

16. The method of claim 12, wherein dividing the granola cluster into the at least one predetermined size comprises utilizing a rotatory screen to break the granola cluster into divided portions.

17. The method of claim 12, wherein reducing the external temperature associated with the granola cluster comprises utilizing a cooling tunnel to apply cooled particles of air that are under at least forty degrees Fahrenheit for at least thirty minutes.

18. A moisture-migration resistant granola comprising:
a granola mixture;
a first moisture layer encapsulating the granola mixture, wherein the first moisture layer comprises a caramelized dry corn syrup solid power; and
a second moisture layer encapsulating the first moisture layer, wherein the second moisture layer comprises a melted fat with a melting point that meets or exceeds a predetermined temperature threshold.

19. The moisture-migration resistant granola of claim 18, further comprising a third moisture layer encapsulating the second moisture layer, wherein the third moisture layer comprises one or more of palm fat, cocoa fat, sunflower fat, or soy lecithin.

20. The moisture-migration resistant granola of claim 18, wherein the predetermined temperature threshold is 90 degrees Fahrenheit.
